(19) United States
(12) Patent Application Publication
(10) Pub. No.: US 2010/0171679 A1
(43) Pub. Date: Jul. 8, 2010

(54) Composite Antenna Element

(76) Inventor: Akihiro Ohshima, Tokyo (JP)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/554,020

(22) Filed: Sep. 4, 2009

(30) Foreign Application Priority Data
Jan. 6, 2009 (JP) P2009-000548

(51) Int. Cl. H01Q 21/00; H01Q 1/38

(52) U.S. Cl. 343/893; 343/700 MS

(57) ABSTRACT

A composite antenna element includes a dielectric substrate having a first face. A first antenna pattern is provided on the first face and has loop shape. A second antenna pattern is provided on the first face and is surrounded by the first antenna pattern. A first conductor plate opposes the first face. The first conductor plate has loop shape, and covers at least a part of the first antenna pattern. A second conductor plate opposes the first face. The second conductor plate is surrounded by the first conductor plate, and covers at least a part of the second antenna pattern.

### BACKGROUND

The present invention relates to an antenna element, and more particularly to a composite antenna element that receives two kinds of radio waves.

In this technical field, it is well known that various kinds of antennas are currently mounted on a vehicle. For instance, as such an antenna, an antenna for a GPS (Global Positioning System), an antenna for an SDARS (Satellite Digital Audio Radio Service), an antenna for an ETC (Electronic Toll Collection System), etc. are exemplified.

The GPS is a satellite positioning system using a satellite. The GPS receives radio waves (GPS signals) from at least 4 artificial satellites of 24 satellites orbiting the earth to measure a positional relation between a mobile object and the artificial satellites or a time error from the received radio waves so that the position or the altitude of the mobile body on a map can be highly accurately calculated on the basis of the principle of a trigonometrical survey. The frequency of the GPS signal is 1.57542 GHz±1.023 MHz.

In recent years, the GPS is used for a car navigation system for detecting the position of a moving vehicle for example, and widely spread. A car navigation device includes an antenna for the GPS for receiving the GPS signal, a processor for processing the GPS signal received by the antenna for the GPS to detect the current position of the vehicle and a display device for displaying the position detected by the processor on a map. As the antenna for the GPS, a plane antenna such as a patch antenna is used.

On the other hand, the SDARS is a service by a digital broadcasting using an SDARS satellite in U.S.A. In U.S.A., a digital radio receiver is developed and put to practical use by which a satellite wave or a ground wave from the SDARS satellite is received so that the digital radio broadcasting can be listened to. At present, in U.S.A., two broadcasting stations of XM and Sirius present radio programs of 250 channels or more in total to the whole country. The digital radio receiver can be ordinarily mounted on a mobile object such as a vehicle to receive an SBARS signal having a frequency of 2.33875 GHz±6 MHz and listen to the radio broadcasting. Namely, the digital radio receiver is a radio receiver by which a mobile broadcasting can be listened to. Since the frequency of a received radio wave is located within a band of about 2.3 GHz, the wavelength (resonance wavelength)λ of the received radio wave is about 128.3 mm. The ground wave is transmitted in such a way that the satellite wave is temporarily received by an earth station, then, a frequency thereof is slightly shifted and then the satellite wave is retransmitted in a linearly-polarized wave. That is, the satellite wave is a circularly-polarized wave. As compared therewith, the ground wave is the linearly polarized wave. As an antenna for the SDARS, the plane antenna such as the patch antenna is used.

An antenna device for an XM satellite radio receives circularly-polarized radio waves from two geostationary satellites, and receives the radio wave by ground linearly-polarized wave equipment in a blind zone. On the other hand, an antenna device for a Sirius satellite radio receives the circularly-polarized waves from three orbiting satellites (synchronous type) and receives the radio wave by the ground linearly polarized wave equipment in the blind zone.

As described above, the radio wave having the frequency located within the band of about 2.3 GHz is used in the digital radio broad casting. In order to mount the digital radio receiver that receives the radio wave on the mobile object such as the vehicle an antenna device thereof is attached on a roof of the vehicle.

Accordingly, as a composite antenna device, an antenna device may be supposed to be used that includes together a first plane antenna element used for the antenna for the GPS and a second plane antenna element used for the antenna for the SDARS.

The ETC is a system developed as a countermeasure to mitigate a delay in a toll gate for paying the passage fee of a toll road such as an express highway. The ETC is a system for automatically paying the passage fee by using a radio communication in the toll gate of the express highway. In the ETC, a bidirectional communication is carried out between an antenna of a road side provided in a gate installed in the toll gate and a passing vehicle on which a communication device to be mounted on the vehicle that has the antenna for the ETC to obtain vehicle information of the passing vehicle so that a payment work of the passage fee of the express highway can be realized without stopping the passing vehicle.

A composite antenna device provided with both the antenna for the GPS and the antenna for the ETC are known (for instance, see Patent Document 1). The antenna device disclosed in the Patent Document 1 includes an antenna element for a GPS for receiving a GPS signal, an antenna element for an ETC for receiving an ETC signal, a circuit board having a processing circuit for processing the GPS signal and the ETC signal, and an output cable for outputting the processed GPS signal and the processed ETC signal. According to the disclosure of the Patent Document 1, the antenna element provided together with the antenna element for the GPS may be not only the antenna element for the ETC, but other antenna elements for receiving radio communication signals such as an antenna for the digital radio broadcasting.

Further, an antenna device is also proposed that includes a plurality of antennas for receiving different radio waves from each other (for instance, see Patent Document 2). The antenna device disclosed in the Patent Document 2 includes a case that integrally supports a plurality of standing antennas and one cable that synthesizes signals received by the plurality of the antennas and transmits the synthesized signal to a receiver main body.

An antenna device is also proposed that has a structure capable of receiving radio waves of two frequencies and downsizing an entire structure (for instance, see Patent Document 3). The antenna device disclosed in the Patent Document 3 includes: a case; a coil antenna for a first frequency; and a patch antenna for a second frequency having a patch antenna element and a ground plane. The antenna device disclosed in the Patent Document 3 is configured to have a three-layer structure in which the coil antenna is arranged in an upper part in the case, the patch antenna element is arranged in an intermediate part and the ground plane is arranged in a lower part. In the antenna device disclosed in the Patent Document 3, the patch antenna is an antenna for transmitting and receiving a radio wave of UHF (for instance, 900 MHz) as a high frequency and the coil antenna is an antenna for transmitting and receiving a radio wave of short wave (for instance, 13.56 MHz) as a low frequency.

Further, a patch antenna is proposed that has antenna characteristics of a high antenna directional gain in a high elevation angle (for instance, see Patent Document 4). In the patch antenna disclosed in the Patent Document 4, a wave director is provided in its top surface. The wave director includes a cushion member attached to the top surface of the patch antenna and a metal ring disposed on the cushion member.

[Patent Document 1] Japanese Patent Publication No. 2002-111377 A

[Patent Document 2] Japanese Patent Publication No. 2002-50925 A

[Patent Document 3] Japanese Patent Publication No. 2007-150827 A

[Patent Document 4] Japanese Patent Publication No. 2006-237813 A

As disclosed in the Patent Documents 1 and 2, the composite antenna that receives the two kinds of radio waves is provided with both the two antenna elements. Accordingly, the antenna device is enlarged.

On the other hand, the antenna device disclosed in the Patent Document 3 can transmit and receive the radio waves of two frequencies. However, the two frequencies of the radio waves are considerably separated from each other. In other words, the two frequencies close to each other cannot be transmitted and received.

The patch antenna disclosed in the Patent Document 4 merely shows the wave director provided on its top surface to increase the antenna directional gain in the high elevation angle and cannot receive the two kinds of radio waves.

Referring to FIGS. 1 to 3, a conventional composite antenna element 10 will be described in order to easily understand the present invention. In FIGS. 1 to 3, a front-rear direction (length) is represented by an X-axis direction, a right-left direction (width) is represented by a Y-axis direction and an up-down direction (height or thickness) is represented by a Z-axis direction.

The composite antenna element 10 shown in FIG. 1 is an antenna element for receiving first radio wave having a first frequency and a second radio wave having a second frequency, which the first and second frequencies are different from each other. The composite antenna element 10 includes a substantially parallelepiped dielectric substrate 12, first and second antenna patterns 14-1 and 14-2, a ground pattern 16, a rod shaped feeding pin 18 and a feeding pattern 19.

As the dielectric substrate 12, a ceramic material having a high electric permittivity (for instance, a specific relative permittivity ∈ᵣ is 20) such as barium titanate is employed. The dielectric substrate 12 has a top surface 12u and a bottom surface 12d opposed to each other in the Z-axis direction and side surfaces 12s. The dielectric substrate 12 is formed with a substrate through hole 12t (FIG. 3) that passes through from the top surface 12u to the bottom surface 12d at a position where a feeding point 15 is disposed.

In an example shown in the drawings, dimensions of the dielectric substrate 12 show that a length in the X-axis direction represented as L_{d} in is 27 mm, a length in the Y-axis direction represented as W_{d} is 27 mm, and a height Hd in the Z-axis direction is 4 mm.

The first antenna pattern 14-1 is made of an electrically conductive film and formed on an outer peripheral part of the top surface 12u of the dielectric substrate 12. The first antenna pattern 14-1 has rectangular loop shape. In the corner parts of a right interior part and a left front part, cutout parts 14-1a are formed. The first antenna pattern 14-1 is formed by, for instance, printing a pattern made of silver.

The second antenna pattern 14-2 is made of an electrically conductive film and formed on a central part of the top surface 12u of the dielectric substrate 12. The illustrated second antenna pattern 14-2 has rectangular shape having the dimension of 11.8 mm×11.85 mm. The second antenna pattern 14-2 is surrounded by the first antenna pattern 14-1 and separated with a little gap from the first antenna pattern 14-1. The second antenna pattern 14-2 is formed by, for instance, printing a pattern made of silver.

As shown in FIG. 2, the ground pattern 16 is made of an electrically conductive film and formed on the bottom surface 12d of the dielectric substrate 12. The ground pattern 16 includes a ground through hole 16a substantially concentric with the substrate through hole 12t and having a diameter larger than the diameter of the substrate through hole 12t.

At the position displaced from the center of the second antenna pattern 14-2 in the X-axis direction and the Y-axis direction, a feeding point 15 is provided. One end 18a of the feeding pin 18 is connected to the feeding point 15. The other end 18b of the feeding pin 18 is guided through the substrate through hole 12t and the ground through hole 16a to a lower side separated from the ground pattern 16. A solder is used as the feeding point 15. Accordingly, the feeding point 15 has convex shape protruding upward from a main face of the second antenna pattern 14-2.

The feeding pattern 19 is formed on the upper surface 12u of the dielectric substrate 12 and feeds an electric power to the first antenna pattern 14-1 by an electromagnetic coupling. As shown in FIG. 1, the feeding pattern 19 is arranged with a prescribed gap spaced from the first antenna pattern 14-1. The size of the gap is changed so that impedance can be adjusted.

In the composite antenna element 10 having such a structure, the combination of the first antenna pattern 14-1, the ground pattern 16 and the feeding pattern 19 serves as a first antenna pattern 10-1 for receiving the first radio wave. Further, the combination of the second antenna pattern 14-2, the ground pattern 16 and the feeding pin 18 serves as a second antenna pattern 10-2 for receiving the second radio wave.

That is, the first antenna pattern 10-1 is formed with a loop antenna and the second antenna pattern 10-2 is formed with a patch antenna.

In the illustrated example, the first antenna pattern 10-1 is formed with an antenna pattern for a GPS that receives a GPS signal from a GPS satellite as the first radio wave. The second antenna pattern 10-2 is formed with an antenna pattern for an SDARS that receives an SDARS signal from an SDARS satellite as the second radio wave.

As shown in FIG. 1, in the conventional composite antenna element 10, the first and second antenna patterns 14-1 and 14-2 are disposed on one plane (the top surface 12u of the dielectric substrate 12). In such a composite antenna element 10, the first antenna pattern 14-1 for a low frequency side radio wave and the second antenna pattern 14-2 for a high frequency side radio wave need to be arranged closely to each other.

In the composite antenna element 10 as shown in FIG. 1 in which the patch antenna 10-2 including the second antenna pattern 14-2 for a second frequency band is disposed in the loop antenna 10-1 including the first antenna pattern 14-1 for a first frequency band, a working frequency band of the loop antenna 10-1 is determined in accordance with the diameter of a loop of the first antenna pattern 14-1, and a working frequency band of the patch antenna 10-2 is determined in accordance with an outer contour shape of the second antenna pattern 14-1.

As described above, the frequency of the GPS signal is 1.57542 GHz±1.023 MHz and the frequency of the SDARS signal is 2.33875 GHz±6 MHz. In such a state that the two working frequency bands are relatively close to each other, the composite antenna element 10 is supposed to try to be adjusted for the frequency thereof. In that case, since the two antenna patterns 14-1 and 14-2 come into contact with each other or are overlapped, the composite antenna element 10 cannot be formed.

### SUMMARY

It is therefore one advantageous aspect of the invention to provide a composite antenna element that can receive radio waves of two frequencies close to each other.

It is another advantageous aspect of the invention to provide a composite antenna element that can easily adjust resonance frequency characteristics.

It is therefore another advantageous aspect of the invention to provide a composite antenna element that can receive a GPS signal and an SDARS signal as the radio waves of two frequencies close to each other.

According to one aspect of the invention, there is provided a composite antenna element comprising:

a dielectric substrate having a first face;

a first antenna pattern provided on the first face and having loop shape;

a second antenna pattern provided on the first face and surrounded by the first antenna pattern;

a first conductor plate opposing the first face, having loop shape, and covering at least a part of the first antenna pattern; and

a second conductor plate opposing the first face, surrounded by the first conductor plate, and covering at least a part of the second antenna pattern.

The composite antenna element may be configured such that: the second antenna pattern is entirely covered by the second conductor plate and the first antenna pattern is not entirely covered by the first conductor plate.

The composite antenna element may be configured such that: the second antenna pattern has oblong shape.

The composite antenna element may further comprise: a power feeding pattern provided on the first face and configured to feed power to the first antenna pattern through electromagnetic coupling; and a power feeding pin extending through the dielectric substrate and electrically connected to the second antenna pattern.

The composite antenna element may further comprise: an earth pattern provided on a second face of the dielectric substrate opposite to the first face, wherein: the first antenna pattern, the earth pattern, and the power feeding pin constitute a first antenna configured to receive first electric waves; and the second antenna pattern, the earth pattern, and the power feeding pattern constitute a second antenna configured to receive second electric waves.

The composite antenna element may be configured such that: the first antenna is configured to receive a signal from a satellite of Satellite Digital Audio Radio Service; and the second antenna is configured to receive a signal from a GPS satellite.

The composite antenna element may be configured such that: the dielectric substrate is made of ceramic material.

The composite antenna element may be configured such that: the first antenna pattern is made of silver; and the second antenna pattern is made of silver.

The composite antenna element may further comprise: a film mounting the first conductor plate and the second conductor plate thereon.

### BRIEF DESCRIPTION OF THE DRAWINGS

FIG. 1 is a plan view of a conventional composite antenna element.

FIG. 2 is a bottom view of the conventional composite antenna element shown in FIG. 1.

FIG. 3 is a front view of the conventional composite antenna element shown in FIG. 1.

FIG. 4 is a perspective view of a composite antenna element according to an embodiment of the present invention.

FIG. 5 is a right side view of the composite antenna element shown in FIG. 4.

FIG. 6 is a plan view for explaining specific dimensions of first and second antenna patterns used in the composite antenna element shown in FIG. 4.

FIG. 7 is a plan view for explaining a specific dimension of a conductor plate used in the composite antenna element shown in FIG. 4.

FIG. 8 is a diagram showing frequency characteristics of a first antenna pattern of the composite antenna element having the conductor plate shown in FIG. 4 and the conventional composite antenna element having no conductor plate shown in FIG. 1.

FIG. 9 is a diagram showing frequency characteristics of a second antenna pattern of the composite antenna element having the conductor plate shown in FIG. 4 and the conventional composite antenna element having no conductor plate shown in FIG. 1.

FIG. 10 is a diagram showing the frequency characteristics of the first antenna pattern of the composite antenna element shown in FIG. 4 obtained when a height h is changed to 0.8 mm, 1.0 mm, 1.5 mm and 2.0 mm.

FIG. 11 is a diagram showing the frequency characteristics of the second antenna pattern of the composite antenna element shown in FIG. 4 obtained when a height h is changed to 0.8 mm, 1.0 mm, 1.5 mm and 2.0 mm.

FIG. 12 is a diagram showing the frequency characteristics of the first antenna pattern of the composite antenna element shown in FIG. 4 obtained when a slit width d is changed to 1 mm, 2 mm, 3 mm and 4 mm.

FIG. 13 is a diagram showing the frequency characteristics of the second antenna pattern of the composite antenna element shown in FIG. 4 obtained when a slit width d is changed to 1 mm, 2 mm, 3 mm and 4 mm.

FIG. 14 is a diagram showing the frequency characteristics of the first antenna pattern of the composite antenna element shown in FIG. 4 obtained when an outer dimension Lₘᵢ of an inner conductor part is changed to 10 mm, 12 mm, 14 mm and 16 mm.

FIG. 15 is a diagram showing the frequency characteristics of the second antenna pattern of the composite antenna element shown in FIG. 4 obtained when an outer dimension Lₘᵢ of an inner conductor part is changed to 10 mm, 12 mm, 14 mm and 16 mm.

### DETAILED DESCRIPTION OF EXEMPLIFIED EMBODIMENT

Referring to the accompanied drawings, exemplified embodiments of the present invention will be described below in detail.

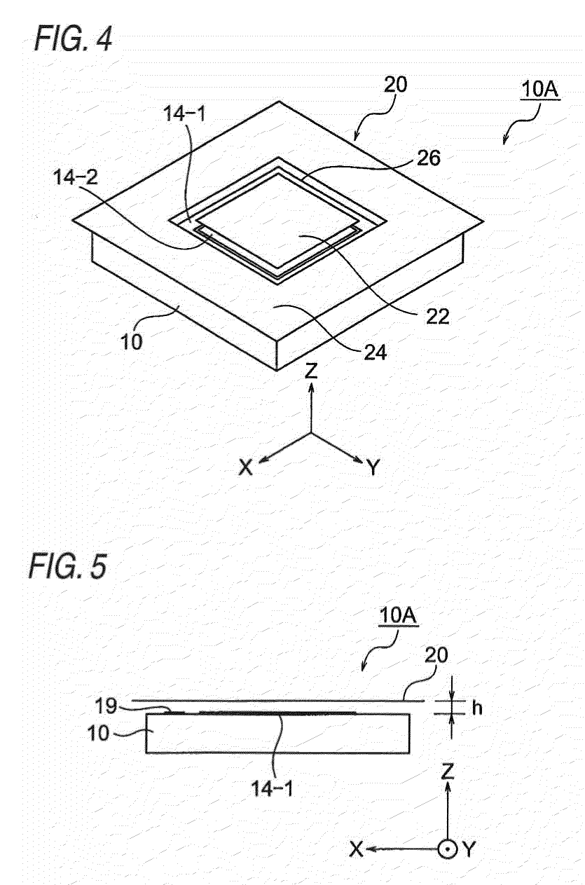

Referring to FIGS. 4 and 5, a composite antenna element 10A according to an embodiment of the present invention will be described. In FIGS. 4 and 5, a front-rear direction (length) is represented by an X-axis direction, a right-left direction (width) is represented by a Y-axis direction and a up-down direction (height or thickness) is represented by a Z-axis direction.

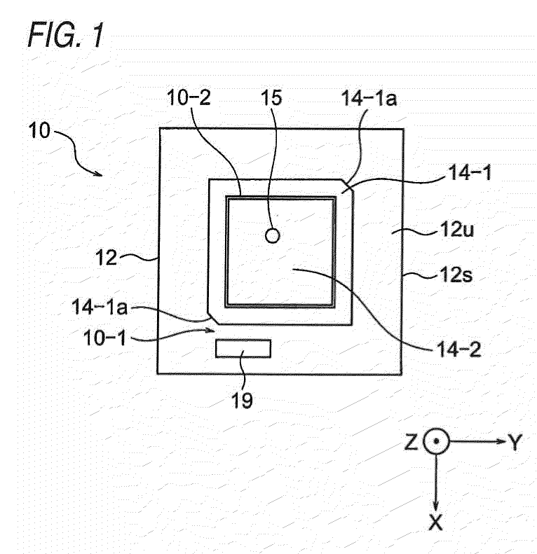

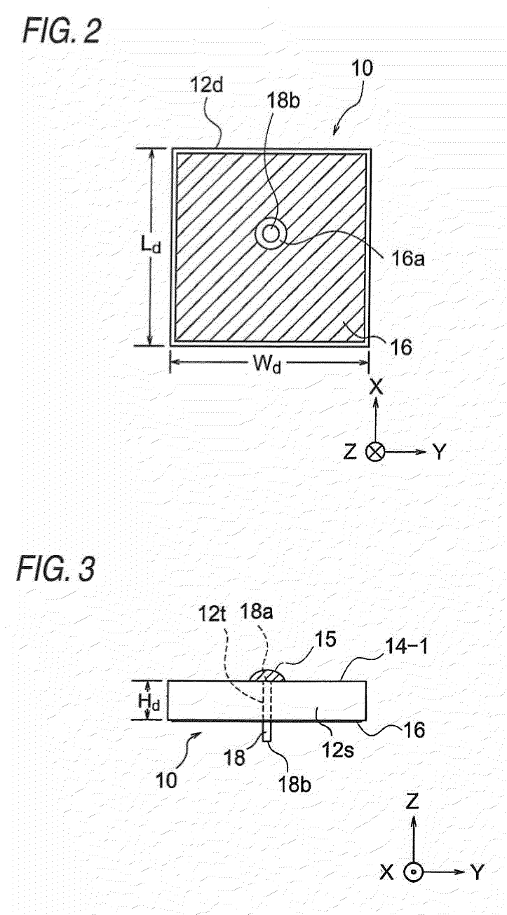

The illustrated composite antenna element 10A has the same structure as that of the conventional composite antenna element 10 shown in FIG. 1 except that a conductor plate 20 is further included. Accordingly, members having the same functions as those shown in FIGS. 1 to 3 are designated by the same reference numerals, and a duplicated explanation will be omitted and only differences will be described below.

The conductor plate 20 is disposed above with a prescribed height h spaced from first and second antenna patterns 14-1 and 14-2. Between the conductor plate 20 and a dielectric substrate 12, a spacer not shown in the drawing is disposed. The spacer is preferably arranged at a corner part of the dielectric substrate 12. In this case, the spacer is more preferably disposed at the corner part of the dielectric substrate 12 that have no cutout part 14-1a.

In the illustrated example, the conductor plate 20 includes a film plate and a metal foil provided on the film plate. As metal forming the metal foil, copper, aluminum or the like may be used. Further, the conductor plate 20 may be formed with a tin plate.

In the illustrated example, the conductor plate 20 is arranged on the dielectric substrate 12 through the spacers, however, the conductor plate 20 may be suspended from a housing (not shown in the drawing) to ensure the height h between the conductor plate 20 and the dielectric substrate 12.

The conductor plate 20 is formed with an inner conductor part 22 and an outer conductor part 24. The inner conductor part 22 has an outer dimension slightly larger than an outer dimension of the second antenna pattern 14-2 so as to substantially cover the second antenna pattern 14-2 therewith. The outer conductor part 24 is arranged with a prescribed slit width d separated from the inner conductor part 22. The outer conductor part 24 has rectangular loop shape with an inner dimension slightly smaller than an outer dimension of the first antenna pattern 14-1. Accordingly, between the inner conductor part 22 and the outer conductor part 24, a conductor plate slit 26 having rectangular loop shape is formed.

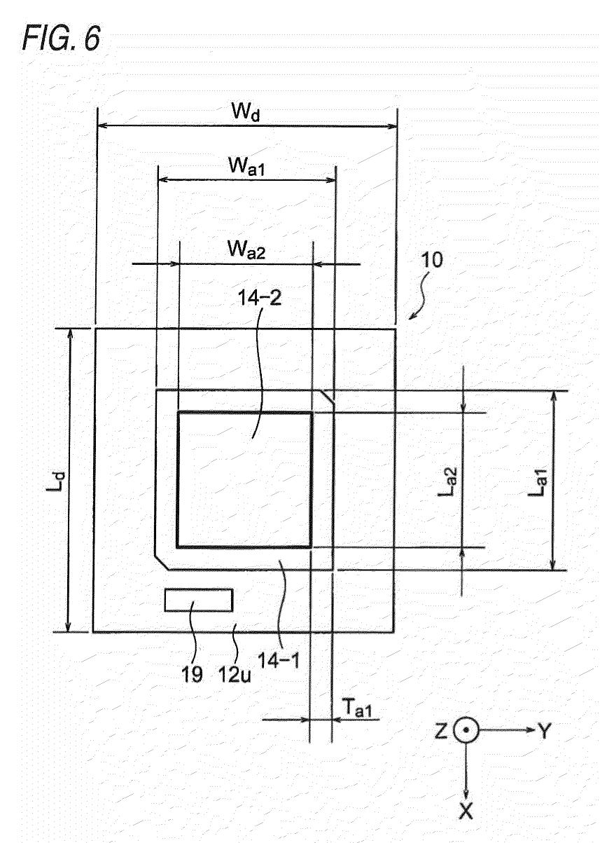

Referring to FIG. 6, there will be described specific dimensions of the first and second antenna patterns 14-1 and 14-2 installed in the composite antenna element 10A.

In the outer dimensions of the first antenna pattern 14-1, a length in the X-axis direction represented as Lₐ₁ is 16.2 mm, and a length in the Y-axis direction represented as Wₐ₁ is 16.2 mm. Namely, the outer contour of the first antenna pattern 14-1 is a square. A loop width Tₐ₁ of the first antenna pattern 14-1 is 2 mm. Accordingly, in the inner dimension of the first antenna pattern 14-1, a length in the X-axis direction is 12.2 mm, and a length in the Y-axis direction is 12.2 mm. Namely, the inner form of the first antenna pattern 14-1 is also a square.

In the outer dimensions of the second antenna pattern 14-2, a length in the X-direction represented as Lₐ₂ is 11.85 mm, and a length in the Y-axis direction represented as Wₐ₂ is 11.8 mm. Namely, the outer contour of the second antenna pattern 14-2 has a rectangular shape slightly longer in the X-axis direction than in the Y-axis direction.

Since the second antenna pattern 14-2 has the rectangular shape being long in the X-axis direction, gaps formed between the first antenna pattern 14-1 and the second antenna pattern 14-2 are different from each other between the X-axis direction and the Y-axis direction.

Specifically described, the gap in the X-axis direction between the first antenna pattern 14-1 and the second antenna pattern 14-2 is expressed by {(Lₐ₁−2Tₐ₁)−Lₐ₂}/2, the gap is 0.175 mm. On the other hand, since the gap in the Y-axis direction between the first antenna pattern 14-1 and the second antenna pattern 14-2 is expressed by {(Wₐ₁−2Tₐ₁)−Wₐ₂}/2, the gap is 0.2 mm.

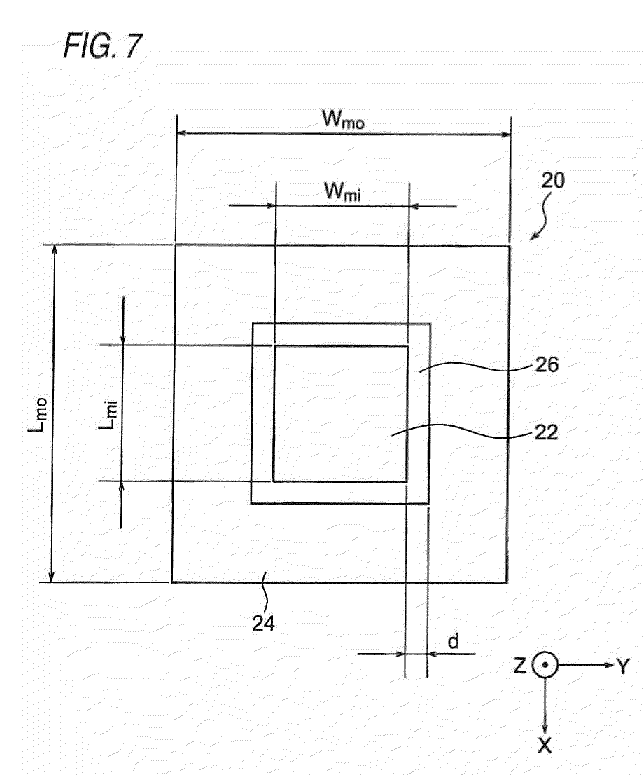

Referring to FIG. 7, there will be described specific dimensions of the conductor plate 20 used in the composite antenna element 10A.

In the outer dimensions of the inner conductor part 22, a length in the X-axis direction represented as Lₘᵢ is 12 mm, and a length in the Y-axis direction represented as Wₘᵢ is 12 mm. Namely, the outer contour of the inner conductor part 22 has square shape. Namely, the outer dimension (Lₘᵢ×Wₘᵢ) of the inner conductor part 22 is slightly larger than the outer dimension (Lₐ₂×Wₐ₂) of the second antenna pattern 14-2.

In the outer dimensions of the outer conductor part 24, a length in the X-axis direction represented as Lₘₒ is 30 mm, and a length in the Y-axis direction represented as Wₘₒ is 30 mm. Namely, the outer contour of the outer conductor part 24 has square shape. A slit width d of the conductor plate slit 26 is 2 mm. Accordingly, in the inner dimension of the outer conductor part 24, a length in the X-axis direction (Lₘᵢ+2d) is 16 mm, and a length in the Y-axis direction (Wₘᵢ+2d) is 16 mm. Namely, the inner dimension of the outer conductor part 24 [(Lₘᵢ+2d)×(Wₘᵢ+2d)] is slightly smaller than the outer dimension (Lₐ₁×Wₐ₁) of the first antenna pattern 14-1.

A distance spaced between the conductor plate 20 and the dielectric substrate 12, that is, the height h is 1.0 mm.

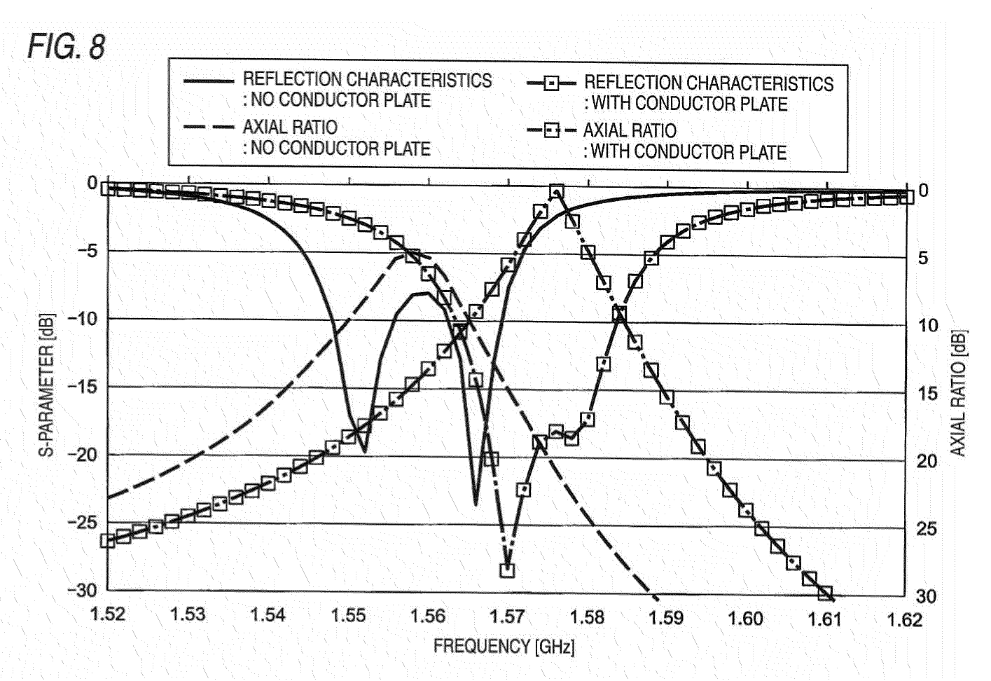

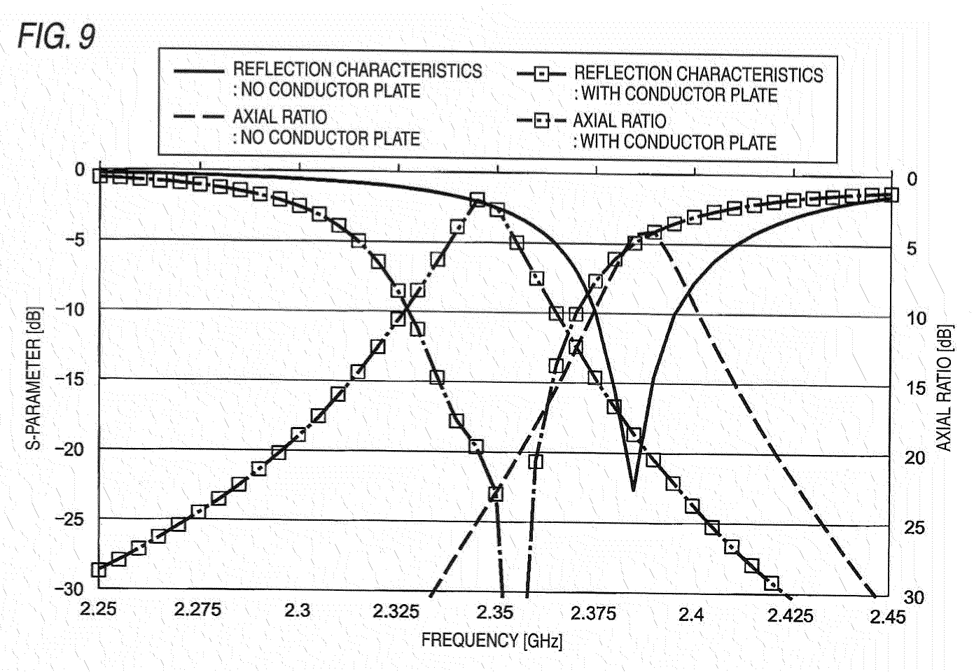

Referring to FIGS. 8 and 9, there will be described frequency characteristics of the composite antenna element 10A having the conductor plate 20 shown in FIG. 4 and the conventional composite antenna element 10 having no conductor element 20 shown in FIG. 1.

As antenna characteristics ordinarily required for the antenna element, the reflection characteristics as shown by an S-Parameter may be preferably −10 dB or lower and the axial ratio may be preferably 3 dB or lower.

In FIGS. 8 and 9 respectively, an axis of abscissa represents a frequency [GHz], a left axis of ordinate represents the S-Parameter [dB] and a right axis of ordinate represents the axial ratio [dB].

As can be understood from FIG. 8, in the first antenna pattern 10-1 of the composite antenna pattern 10A having the conductor plate 20, the S-Parameter is −10 dB or lower within a frequency range of about 1.564 GHz to about 1.584 GHz, and the axial ratio is about 3 dB or lower within a frequency range of about 1.573 GHz to about 1.578 GHz and has a peak of about 0 dB in the frequency of about 1.575 GHz. As compared therewith, in the first antenna pattern 10-1 of the conventional composite antenna element 10 having no conductor plate 20, it is understood that the S-Parameter is −10 db or lower within a frequency range of about 1.547 GHz to about 1.555 GHz and within a frequency range of about 1.562 GHz to about 1.568 GHz, and the axial ratio has a peak of about 5 dB in the frequency of about 1.558 GHz.

Namely, as can be understood from FIG. 8, in the first antenna pattern 10-1 of the composite antenna element 10A having the conductor plate 20, a resonance frequency of a low frequency side shifts more to a high frequency side and the antenna characteristics are better than those of the first antenna pattern 10-1 of the conventional composite antenna element 10 having no conductor plate 20.

As can be understood from FIG. 9, in the second antenna pattern antenna pattern 10-2 of the composite antenna pattern 1A having the conductor plate 20, the S-Parameter is −10 dB or lower within a frequency range of about 2.33 GHz to about 2.37 GHz, and the axial ratio is about 3 dB within a frequency range of about 2.342 GHz to about 2.35 GHz and has a peak of about 2 dB in the frequency of about 2.345 GHz. As compared therewith, in the second antenna pattern 10-2 of the conventional composite antenna element 10 having no conductor plate 20, it is understood that the S-Parameter is −10 dB or lower within a frequency range of about 2.375 GHz to about 2.39 GHz, and the axial ratio has a peak of about 4 dB in the frequency of about 2.38 GHz.

Namely, in the second antenna pattern 10-2 of the composite antenna element 10A having the conductor plate 20, a resonance frequency of a high frequency side shifts more to a low frequency side and the antenna characteristics are better than those of the second antenna pattern 10-2 of the conventional composite antenna element 10 having no conductor plate 20.

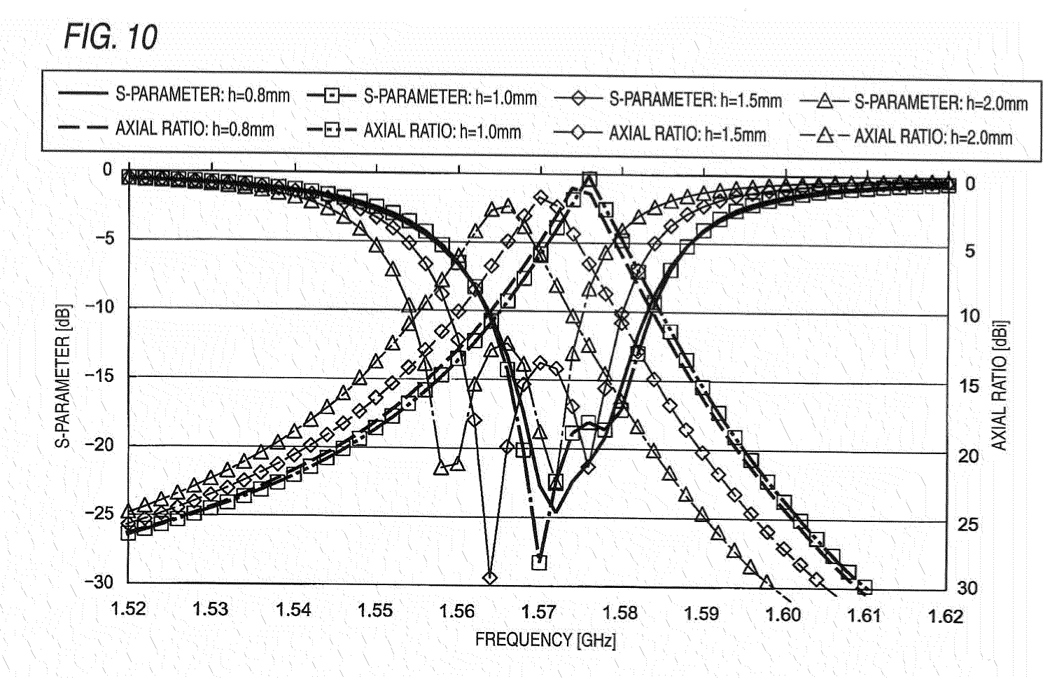

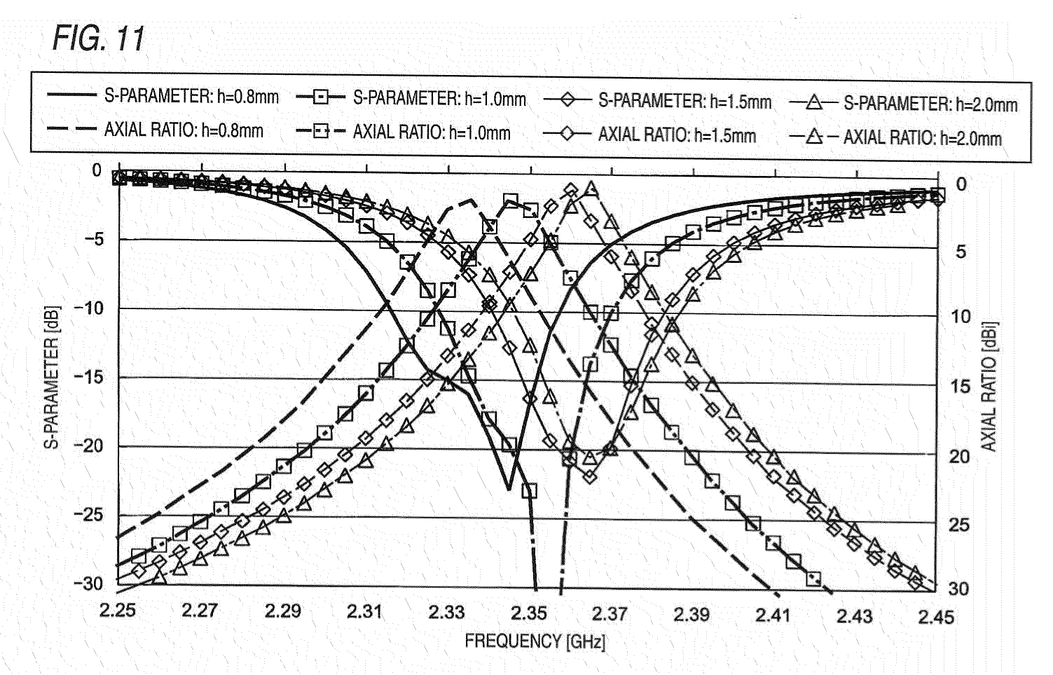

Referring to FIGS. 10 and 11, there will be described the frequency characteristics as shown by the S-Parameter of the composite antenna element 10A obtained when the height h is changed.

As can be understood from FIG. 10, when the height h is 0.8 mm and 1.0 mm, in the first antenna pattern 10-1, the S-Parameter is −10 dB or lower within a frequency range of about 1.564 GHz to about 1.584 GHz, and the axial ratio is about 3 dB or lower within a frequency range of about 1.572 GHz to about 1.577 GHz and has a peak of about 0 dB in the frequency of about 1.575 GHz. As compared therewith, when the height h is 1.5 mm, in the first antenna pattern 10-1, it is understood that the S-Parameter is −10 dB or lower within a frequency range of about 1.576 GHz to about 1.58 GHz, and the axial ratio is about 3 dB or lower within a frequency range of about 1:568 GHz to about 1.573 GHz and has a peak of about 2 dB in the frequency of about 1.57 GHz. Further, when the height h is 2.0 mm, in the first antenna pattern 10-1, it is understood that the S-Parameter is −10 dB or lower within a frequency range of about 1.555 GHz to about 1.576 GHz, and the axial ratio is about 3 dB or lower within a frequency range of about 1.564 GHz to about 1.567 GHz and has a peak of about 2.5 dB in the frequency of about 1.565 GHz.

Further, as can be understood from FIG. 11, when the height h is 1.0 mm, in the second antenna pattern 10-2, the S-Parameter is −10 dB or lower within a frequency range of about 2.33 GHz to about 2.37 GHz, and the axial ratio is about 3 dB or lower within a frequency range of about 2.342 GHz to about 2.351 GHz and has a peak of about 2 dB in the frequency of about 2.345 GHz. As compared therewith, when the height h is 0.8 mm, in the second antenna pattern 10-2, it is understood that the S-Parameter is −10 dB or lower within a frequency range of about 2.315 GHz to about 2.36 GHz, and the axial ratio is about 3 dB or lower within a frequency range of about 2.331 GHz to about 2.337 GHz and has a peak of about 2 dB in the frequency of about 2.335 GHz. When the height h is 1.5 mm, in the second antenna pattern 10-2, it is understood that the S-Parameter is −10 dB or lower within a frequency range of about 2.34 GHz to about 2.385 GHz, and the axial ratio is about 3 dB or lower within a frequency range of about 2.356 GHz to about 2.364 GHz and has a peak of about 1 dB in the frequency of about 2.36 GHz. Further, when the height h is 2.0 mm, in the second antenna pattern 10-2 it is understood that the S-Parameter is −10 dB or lower within a frequency range of about 2.345 GHz to about 2.382 GHz, and the axial ratio is about 3 dB or lower within a frequency range of about 2.359 GHz to about 2.369 GHz and has a peak of about 1 dB in the frequency of about 2.365 GHz.

Accordingly, it can be understood that when the height is 1.0 mm, good antenna characteristics can be attained.

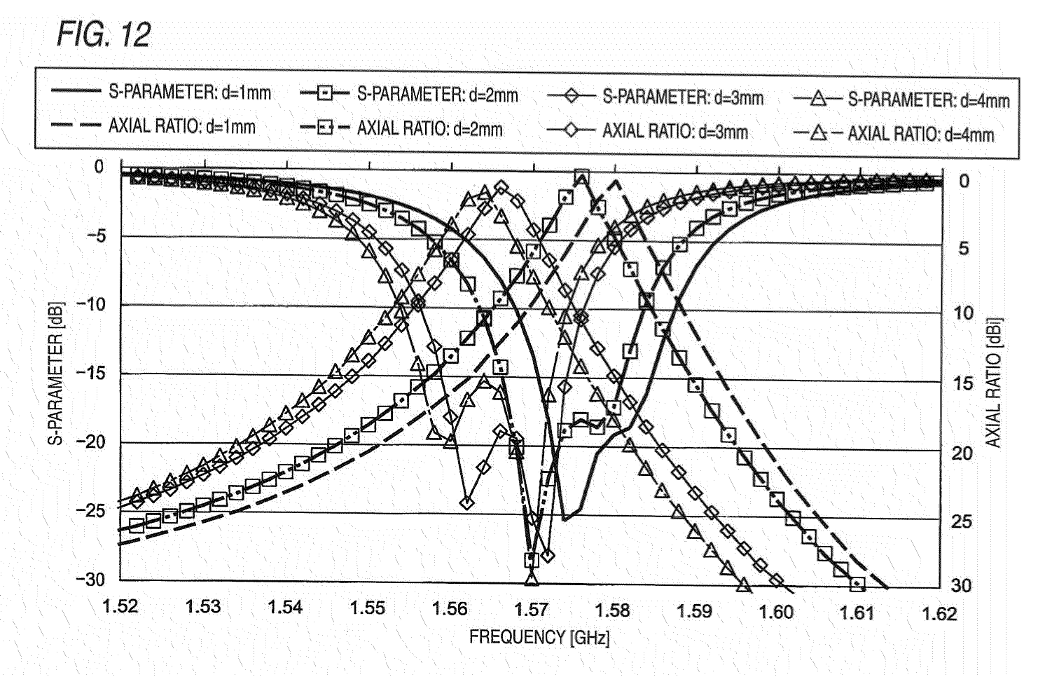

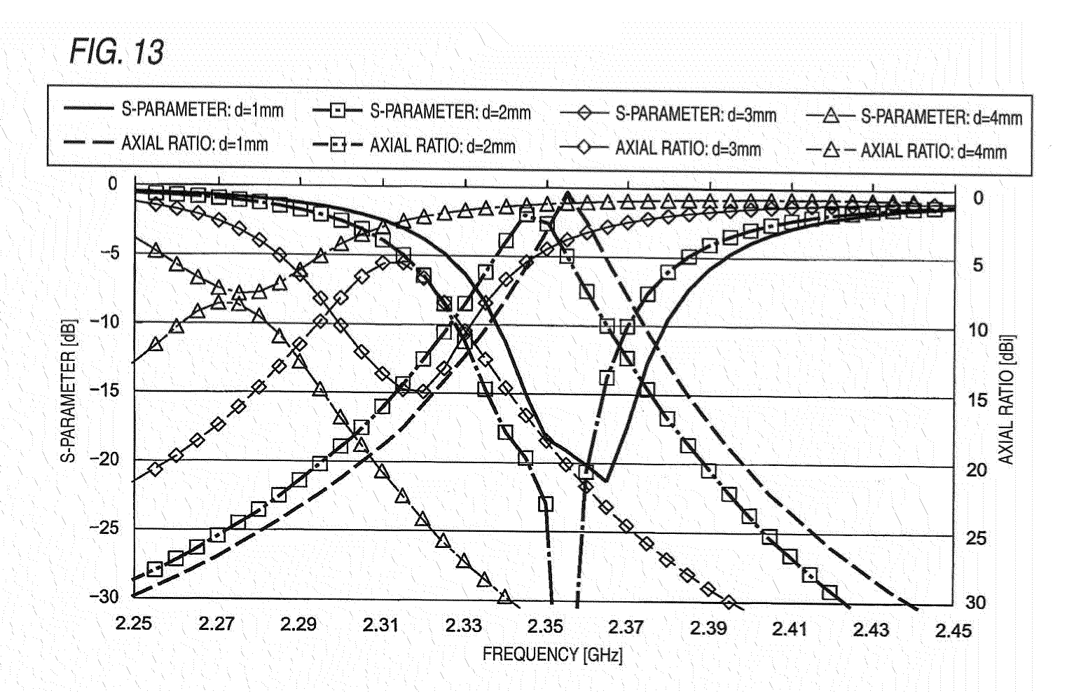

Referring to FIGS. 12 and 13, there will be described the frequency characteristics as shown by the S-Parameter of the composite antenna element 10A obtained when the slit width d is changed.

As can be understood from FIG. 12, when the slit width d is 2 mm, in the first antenna pattern 10-1, the S-Parameter is −10 dB or lower within a frequency range of about 1.564 GHz to about 1.584 GHz, and the axial ratio is about 3 dB or lower within a frequency range of about 1.573 GHz to about 1.579 GHz and has a peak of about 0 dB in the frequency of about 1.575 GHz. As compared therewith, when the slit width d is 1 mm, in the first antenna pattern 10-1, it is understood that the S-Parameter is −10 dB or lower within a frequency range of about 1.568 GHz to about 1.587 GHz, and the axial ratio is about 3 dB or lower within a frequency range of about 1.577 GHz to about 1.582 GHz and has a peak of about 0 dB in the frequency of about 1.58 GHz. Further, when the slit width d is 3 mm, in the first antenna pattern 10-1, it is understood that the S-Parameter is −10 dB or lower within a frequency range of about 1.556 GHz to about 1.576 GHz, and the axial ratio is about 3 dB or lower within a frequency range of about 1.564 GHz to about 1.569 GHz and has a peak of about 1 dB in the frequency of about 1.565 GHz. When the slit width d is 4 mm, in the first antenna pattern 10-1, it is understood that the S-Parameter is −10 dB or lower within a frequency range of about 1.554 GHz to about 1.575 GHz, and the axial ratio is about 3 dB or lower within a frequency range of about 1.561 GHz to about 1.566 GHz and has a peak of about 2 dB in the frequency of about 1.562 GHz.

Further, as can be understood from FIG. 13, when the slit width d is 2 mm, in the second antenna pattern 10-2 the S-Parameter is −10 dB or lower within a frequency range of about 2.33 GHz to about 2.37 GHz, and the axial ratio is about 3 dB or lower within a frequency range of about 2.342 GHz to about 2.351 GHz and has a peak of about 2 dB in the frequency of about 2.345 GHz. As compared therewith, when the slit width is 1 mm, in the second antenna pattern 10-2, it is understood that the S-Parameter is −10 dB or lower within a frequency range of about 2.34 GHz to about 2.38 GHz, and the axial ratio is about 3 dB or lower within a frequency range of about 2.35 GHz to about 2.36 GHz and has a peak of about 0 dB in the frequency of about 2.335 GHz. When the slit width d is 3 mm, in the second antenna pattern 10-2, it is understood that the S-Parameter is −10 dB or lower within a frequency range of about 2.30 GHz to about 2.33 GHz, and the axial ratio has a peak of about 5 dB in the frequency of about 2.315 GHz. When the slit width d is 4 mm, in the second antenna pattern 10-2, it is understood that there is no frequency range where the S-Parameter is −10 dB or lower, and the axial ratio has a peak of about 8 dB in the frequency of about 2.275 GHz.

Accordingly, it can be understood that when the slit width d is in a range of 1 mm to 2 mm, good antenna characteristics can be attained.

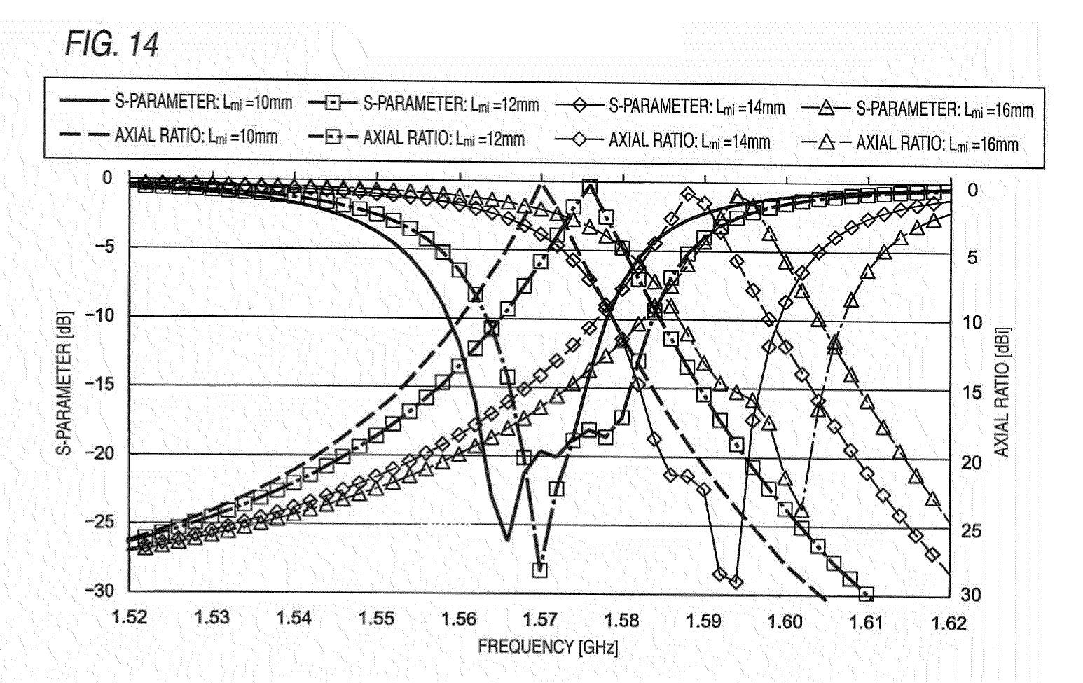

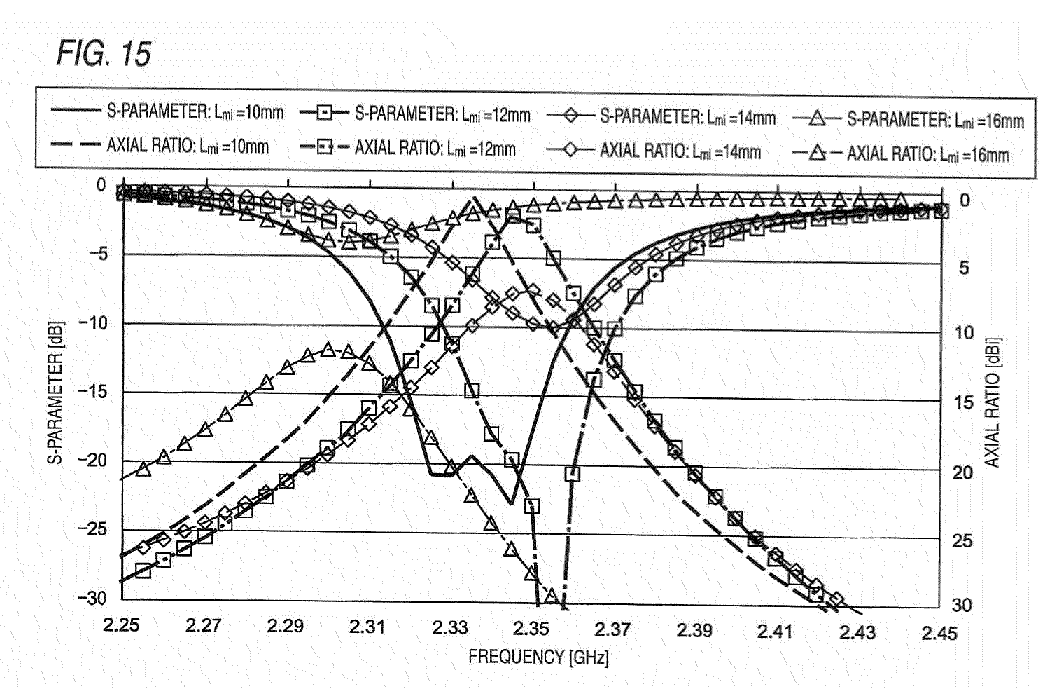

Referring to FIGS. 14 and 15, there will be described the frequency characteristics as shown by the S-Parameter of the composite antenna element 10A obtained when the outer dimension Lₘᵢ of the inner conductor part 22 is changed.

As can be understood from FIG. 14, when the outer dimension Lₘᵢ of the inner conductor part 22 is 12 mm, in the first antenna pattern 10-1, the S-Parameter is −10 dB or lower within a frequency range of about 1.564 GHz to about 1.584 GHz, and the axial ratio is about 3 dB or lower within a frequency range of about 1.573 GHz to about 1.578 GHz and has a peak of about 0 dB in the frequency of about 1.575 GHz. As compared therewith, when the outer dimension Lₘᵢ of the inner conductor part 22 is 10 mm, in the first antenna pattern 10-1, it is understood that the S-Parameter is −10 dB or lower within a frequency range of about 1.568 GHz to about 1.577 GHz, and the axial ratio is about 3 dB or lower within a frequency range of about 1.569 GHz to about 1.573 GHz and has a peak of about 0 dB in the frequency of about 1.57 GHz. Further, when the outer dimension Lₘᵢ of the inner conductor part 22 is 14 mm, in the first antenna pattern 10-1, it is understood that the S-Parameter is −10 dB or lower within a frequency range of about 1.578 GHz to about 1.598 GHz, and the axial ratio is about 3 dB or lower within a frequency range of about 1.586 GHz to about 1.591 GHz and has a peak of about 1 dB in the frequency of about 1.588 GHz. When the outer dimension Lₘᵢ of the inner conductor part 22 is 16 mm, in the first antenna pattern 10-1, it is understood that the S-Parameter is −10 dB or lower within a frequency range of about 1.586 GHz to about 1.607 GHz, and the axial ratio is about 3 dB or lower within a frequency range of about 1.592 GHz to about 1.597 GHz and has a peak of about 1 dB in the frequency of about 1.594 GHz.

Further, as can be understood from FIG. 15, when the outer dimension Lₘᵢ of the inner conductor part 22 is 12 mm, in the second antenna pattern 10-2, the S-Parameter is −10 dB or lower within a frequency range of about 2.33 GHz to about 2.37 GHz, and the axial ratio is about 3 dB or lower within a frequency range of about 2.341 GHz to about 2.35 GHz and has a peak of about 2 dB in the frequency of about 2.345 GHz. As compared therewith, when the outer dimension Lₘᵢ of the inner conductor part 22 is 10 mm, in the second antenna pattern 10-2, it is understood that the S-Parameter is −10 dB or lower within a frequency range of about 2.315 GHz to about 2.36 GHz, and the axial ratio is about 3 dB or lower within a frequency range of about 2.33 GHz to about 2.34 GHz and has a peak of about 1 dB in the frequency of about 2.338 GHz. When the outer dimension Lₘᵢ of the inner conductor part 22 is 14 mm, in the second antenna pattern 10-2, it is understood that the S-Parameter is −10 dB or lower in the frequency of about 2.354 GHz, and the axial ratio has a peak of about 7.5 dB in the frequency of about 2.35 GHz. When the outer dimension Lₘᵢ of the inner conductor part 22 is 16 mm, in the second antenna pattern 10-2, it is understood that there is no frequency range where the S-Parameter is −10 dB or lower, and the axial ratio has a peak of about 12 dB in the frequency of about 2.30 GHz.

Accordingly, it can be understood that when the outer dimension Lₘᵢ of the inner conductor part 22 is in a range of 10 mm to 12 mm, good antenna characteristics can be attained.

Furthermore, the reflection characteristics can be adjusted by changing the outer dimension of the second conductor plate. When the outer dimension of the second conductor plate is changed, a curve of the S-Parameter moves in a direction of the axis of the abscissa while an outline of the curve of the S-parameter not deforming. When the outer dimension of the second conductor becomes larger, the curve of the S-Parameter moves to lower frequency side. When the outer dimension of the second conductor becomes smaller, the curve of the S-Parameter moves to higher frequency side.

Since in the present invention, a conductor plate is arranged with a prescribed height separated from first and second antenna patterns, and the conductor plate includes an inner conductor part with which the second antenna pattern is substantially covered and a rectangular loop shaped outer conductor part arranged with a prescribed slit width separated from the inner conductor part, the composite antenna element can be provided that can receive the radio waves of two frequencies close to each other.

Although only some exemplary embodiments of the invention have been described in detail above, those skilled in the art will readily appreciated that many modifications are possible in the exemplary embodiments without materially departing from the novel teachings and advantages of the invention. Accordingly, all such modifications are intended to be included within the scope of the invention.

For instance, a material of the dielectric substrate may be made of not only the ceramic material but also a resin material. Further, the composite antenna element according to the present invention is suitable for receiving the GPS signal and the SDARS signal, but signals are not limited thereto. The composite antenna element may be used as a composite antenna element that receives first and second radio waves which are adjacent to each other and different from each other. The outer dimension of the second conductor plate may be smaller than the outer dimension of the second antenna pattern. The first and second antenna patterns may have not only rectangular shape but also other shapes, which is circular shape and polygonal shape for example. The first and second conductors may have not only rectangular shape but also other shapes, which is circular shape and polygonal shape for example.

The disclosures of Japanese Patent Application No. 2009-000548 filed Jan. 6, 2009 including specification, drawings and claims is incorporated herein by reference in its entirety.

What is claimed is:

1. A composite antenna element comprising:
a dielectric substrate having a first face;
a first antenna pattern provided on the first face and having loop shape;
a second antenna pattern provided on the first face and surrounded by the first antenna pattern;
a first conductor plate opposing the first face, having loop shape, and covering at least a part of the first antenna pattern; and
a second conductor plate opposing the first face, surrounded by the first conductor plate, and covering at least a part of the second antenna pattern.

2. The composite antenna element as set forth in claim 1, wherein:
the second antenna pattern is entirely covered by the second conductor plate and the first antenna pattern is not entirely covered by the first conductor plate.

3. The composite antenna element as set forth in claim 1, wherein:
the second antenna pattern has oblong shape.

4. The composite antenna element as set forth in claim 1, further comprising:
a power feeding pattern provided on the first face and configured to feed power to the first antenna pattern through electromagnetic coupling; and
a power feeding pin extending through the dielectric substrate and electrically connected to the second antenna pattern.

5. The composite antenna element as set forth in claim 4, further comprising:
an earth pattern provided on a second face of the dielectric substrate opposite to the first face, wherein:
the first antenna pattern, the earth pattern, and the power feeding pin constitute a first antenna configured to receive first electric waves; and
the second antenna pattern, the earth pattern, and the power feeding pattern constitute a second antenna configured to receive second electric waves.

6. The composite antenna element as set forth in claim 5, wherein:
the first antenna is configured to receive a signal from a satellite of Satellite Digital Audio Radio Service; and
the second antenna is configured to receive a signal from a GPS satellite.

7. The composite antenna element as set forth in claim 1, wherein:
the dielectric substrate is made of ceramic material.

8. The composite antenna element as set forth in claim 1, wherein:
the first antenna pattern is made of silver; and
the second antenna pattern is made of silver.

9. The composite antenna element as set forth in claim 1, further comprising:
a film mounting the first conductor plate and the second conductor plate thereon.
